(19) United States
(12) Patent Application Publication
(10) Pub. No.: US 2024/0217182 A1
(43) Pub. Date: Jul. 4, 2024

(54) INTEGRATED THERMAL CONTROL FOR ADDITIVE MANUFACTURING AND COATING

(71) Applicant: VIRGINIA TECH INTELLECTUAL PROPERTIES, INC., Blacksburg, VA (US)

(72) Inventors: Robert J. GRIFFITHS, Blacksburg, VA (US); David GARCIA, Blacksburg, VA (US); Hang YU, Blacksburg, VA (US)

(21) Appl. No.: 18/563,255

(22) PCT Filed: May 26, 2022
(86) PCT No.: PCT/US2022/031121

§ 371 Date: Nov. 21, 2023

Related U.S. Application Data
(60) Provisional application No. 63/193,879, filed on May 27, 2021.

(51) Int. Cl. B29C 64/393; B29C 64/295; B29C 64/364; B33Y 10/00; B33Y 30/00; B33Y 40/20; B33Y 50/02

(52) U.S. Cl. CPC B29C 64/393; B29C 64/295; B29C 64/364; B33Y 10/00; B33Y 30/00; B33Y 40/20; B33Y 50/02

(57) ABSTRACT

A system and method for additive manufacturing are described. A system includes an additive manufacturing tooling head configured to deposit a heated material to form a workpiece, a tooling controller configured direct the tooling head through a sequence of additive manufacturing process actions, and a chamber comprising a build surface to support the workpiece during the sequence of additive manufacturing process actions. At least one thermal medium is positioned within the chamber. The tooling controller is further configured to determine a thermal gradient between the workpiece and the portion of the heated material based on the temperature of the workpiece and the temperature of the portion of the heated material to be deposited, and control the at least one thermal medium contained within the chamber over time based at least in part on a predetermined thermal gradient range.

### CROSS-REFERENCE TO RELATED APPLICATION

This application claims the benefit of and priority to U.S. Provisional Patent Application No. 63/193,879 entitled “INTEGRATED THERMAL CONTROL SYSTEM FOR ADDITIVE MANUFACTURING AND COATING,” filed May 27, 2021, the contents of which being incorporated by reference in their entirety herein.

### BACKGROUND

Many additive manufacturing (AM) and coating processes rely on a thermal input to melt or soften and then fuse materials involved in fabricating a workpiece. For solid-state processes, a thermal input might be applied using a rotating tool or a vibrating tool. In fusion-based processes, thermal inputs may include resistive heating, plasma, flames, lasers, microwaves, electron-beams, and the like. Heat-related melting or softening typically results in a high thermal gradient between a deposited material and a fabricated portion of the workpiece, where the workpiece (or, specifically, the top layer thereof) is generally much colder than the newly added material, commonly resulting in a number of undesired effects. Further, the thermal mismatch during cooling or solidification can result in severe residual stress and even warpage in additively manufactured parts or in coating and/or cladding processes, as well as the formation of undesirable phases and overall weakening of the part.

### BRIEF SUMMARY

In a first aspect, a system for additive manufacturing is described. The system includes an additive manufacturing tooling head configured to deposit a heated material to form a workpiece: a tooling controller configured direct the tooling head through a sequence of additive manufacturing process actions: a chamber comprising a build surface to support the workpiece during the sequence of additive manufacturing process actions; at least one thermal medium contained within the chamber: and at least one sensor configured to detect a temperature of the workpiece and a temperature of a portion of the heated material to be deposited. The tooling controller is further configured to determine a thermal gradient between the workpiece and the portion of the heated material based on the temperature of the workpiece and the temperature of the portion of the heated material to be deposited, and control the at least one thermal medium contained within the chamber over time based at least in part on a predetermined thermal gradient range.

The system may include a temperature and flow regulator for the at least one thermal medium. The tooling controller may be configured to control an amount of the at least one thermal medium and adjust the temperature of the at least one thermal medium contained within the chamber at a location proximate to the tooling head.

In some aspects, the at least one thermal medium is a first thermal medium and a second thermal medium. To this end, the system may further include a first temperature and flow regulator for the first thermal medium and a second temperature and flow regulator for the second thermal medium. The tooling controller may be configured to control an amount of and the temperature of the first thermal medium contained within the chamber using the first temperature regulator. The tooling controller may be configured to control an amount of and the temperature of the second thermal medium contained within the chamber using the second temperature regulator. In some aspects, the first thermal medium has a density, viscosity, and thermal characteristics different than the second thermal medium.

The tooling controller may be further configured to cool or heat the entire workpiece at a controlled rate after the sequence of additive manufacturing process actions to form the workpiece. In some aspects, the tooling controller is further configured to regulate a first portion of the medium to a first temperature and to regulate a second portion of the medium to a second temperature, where the first temperature is higher than the second temperature: and where the first portion of the medium surrounds a location of the workpiece proximate to the tooling head and the second portion of the medium is below the first portion of the medium.

The build surface may be adjustable in position within the chamber, and the tooling controller is configured to control a position of the build surface during the sequence of additive manufacturing process actions. For instance, the build surface may be vertically adjustable in position within the chamber, where the tooling controller is configured to control a vertical position of the build surface during the sequence of additive manufacturing process actions.

In some aspects, the at least one sensor is a first sensor configured to measure a temperature of the workpiece and a second sensor configured to measure a temperature of a portion of the heated material to be deposited. The system may further include a third sensor configured to measure an amount of the at least one thermal medium in the chamber. The tooling controller may be further configured to adjust the temperature of the at least one thermal medium such that a temperature of the workpiece and a temperature of the portion of the heated material to be deposited are within the predetermined thermal gradient range.

In a second aspect, a method for use in additive manufacturing is described. The method may include directing, with a controller, an additive manufacturing tooling head to form a workpiece through deposit of material according to a sequence of additive manufacturing process actions: measuring, with the controller, a temperature of at least one thermal medium within a chamber, the chamber comprising a build surface to support the workpiece during the sequence of additive manufacturing process actions; and adjusting, with the controller, the temperature of the at least one thermal medium contained within the chamber over time, by control of a temperature regulator, based on the sequence of additive manufacturing process actions.

The method may further include elevating the temperature of the at least one thermal medium contained within the chamber at a location proximate to the tooling head. The method may further include cooling or heating the workpiece at a controlled rate after the sequence of additive manufacturing process actions to form the workpiece. The method may further include regulating a first portion of the at least one thermal medium to a first temperature and regulating a second portion of the at least one thermal medium to a second temperature, where the first temperature is higher than the second temperature.

In some aspects, the first portion of the at least one thermal medium surrounds a location of the workpiece proximate to the tooling head and the second portion of the at least one thermal medium is below the first portion of the medium. The at least one thermal medium contained within the chamber may include a first thermal medium and a second thermal medium. The method may further include regulating the first thermal medium to a first temperature and regulating the second thermal medium to a second temperature.

The method may further include adjusting a position of the build surface during the sequence of additive manufacturing process actions. Additionally, the method may include maintaining a constant amount of the at least one thermal medium in the chamber and adjusting a vertical position of the build surface during the sequence of additive manufacturing process actions. In some aspects, the method includes measuring, by a first sensor, a temperature of the workpiece: measuring, by a second sensor, a temperature of a portion of the heated material to be deposited: and measuring, by a third sensor, an amount of the at least one thermal medium in the chamber. In some aspects, the method includes adjusting, by the controller, the temperature of the at least one thermal medium such that a temperature of the workpiece and a temperature of the portion of the heated material to be deposited are within the predetermined thermal gradient range.

In some aspects, the at least one thermal medium includes a first thermal medium and a second thermal medium. The controller may selectively control thermal effects of the first thermal medium and the second thermal medium by controlling a relative location and a relative amount of the first thermal medium and the second thermal medium, respectively, where the relative location and relative amount of the first thermal medium and the second thermal medium are controlled by at least one temperature and flow regulator based on at least one of inherit phase, density, solubility, temperature, and viscosity of the first thermal medium and the second thermal medium.

In some aspects, the method may further includes providing a boundary material that separates the first thermal medium and the second thermal medium in the chamber, and selectively controlling the boundary material to be positioned at a predetermined location, where the boundary material restricts mixing of adjacent ones of the first thermal medium and the second thermal medium.

In a third aspect, a method for coating a workpiece is described that includes directing, with a controller, a tooling head to coat a workpiece through deposit of material according to a sequence of coating process actions: measuring, with the controller, a temperature of at least one thermal medium within a chamber, the chamber comprising a build surface to support the workpiece during the sequence of coating process actions; and adjusting, with the controller, the temperature of the at least one thermal medium contained within the chamber over time, by control of a temperature regulator, based on the sequence of coating process actions.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is an example of a system for controlling thermal gradients in additive manufacturing in accordance with various embodiments of the present disclosure.

FIG. 2 is another example of a system for control thermal gradients in additive manufacturing in accordance with various embodiments of the present disclosure.

FIG. 3 is an example of additive manufacturing in the related art in which high residual stress and warpage are generated within a workpiece during fabrication.

FIG. 4 is another example of additive manufacturing in the related art in which residual stress and thermal mismatches are generated within a workpiece during fabrication.

FIG. 5 is another example of additive manufacturing in the related art in which damage or deterioration of a workpiece are common due to excessive prolonged heating.

FIG. 6 is an example of fabrication of a workpiece using the system for controlling thermal gradients in additive manufacturing of FIG. 1 in accordance with various embodiments of the present disclosure.

FIG. 7 is a photograph of a workpiece fabricated using the system for controlling thermal gradients in additive manufacturing of FIG. 1 in accordance with various embodiments of the present disclosure.

FIG. 8 is an example flowchart for controlling thermal gradients in additive manufacturing in accordance with various embodiments of the present disclosure.

### DETAILED DESCRIPTION

The present disclosure relates to an integrated thermal control system for additive manufacturing processes, coating processes, and so forth. Additive manufacturing (AM), also known as three-dimensional (3D) printing, is a rapidly growing area of technological focus. Additive manufacturing has numerous applications and implications as complex components are able to be fabricated and rapidly produced. In additive manufacturing processes, heat is applied to melt or otherwise change viscosity of a material, such as a polymer or a metal, where the melted or heated material is applied over a given area to ultimately generate a component formed up of a deposit of a multitude of individual layers. A layer of a material is generally applied to a top or bottom surface of a partially fabricated workpiece by directing a position of a depositing tooling head (also referred to as a “tooling” for short, “toolhead,” or “printhead”) and a selective release of the heated material.

As noted above, heat-related melting or softening typically results in a high thermal gradient between a deposited material and a remaining portion of a workpiece to be manufactured, where the workpiece is generally much colder than the newly added material. For instance, a top surface (or bottom surface in bottom-up approaches) of a workpiece being formed has a temperature substantially different than that of heated material to be deposited on the top surface. This often results in a number of detrimental or undesirable effects applied to a workpiece to be constructed, reducing resolution and performance of formed workpieces. Further, thermal mismatch during cooling or solidification can result in severe residual stress and even warpage in additively manufactured parts or in coating and/or cladding processes.

Accordingly, various embodiments are disclosed for interfacing with various additive manufacturing (AM) technologies, coating technologies, and other analogous systems. The embodiments described herein allow for immediate and continuous control of temperature of a workpiece on a site-by-site basis. According to various embodiments, a collapsing and/or expanding vessel may be selectively filled with one or more thermal mediums as material is deposited during AM processes, coating processes, and the like.

Inherit differences in the thermal mediums (or applied barrier layers between the thermal mediums) may permit the thermal mediums to separate and apply different thermal effects on a location-by-location basis. For instance, a first type of thermal medium (or a “first thermal medium”) may be selectively released to heat or cool a first portion of a workpiece, whereas a second type of thermal medium (or a “second thermal medium) may be selectively released to heat or cool a second portion of the workpiece. In some embodiments, the thermal medium may include gasses, liquids, solids, or any combination thereof, with a specific type of thermal medium being selected based on an intended role, such as insulation, rapid heating, rapid cooling, temperature stability, and so forth.

Accordingly, instantaneous temperature and/or heating and cooling rates may be controlled, where a workpiece or thermal medium can be kept above or below nominal conditions associated with manufacturing. The embodiments described herein allow for discrete and precise control of a complete thermal profile for a workpiece (e.g., a manufactured material or item), including temperature rate changes, isothermal holds, controlled thermal gradients, and the like. The thermal control enabled by the embodiments described herein may improve capabilities of several technologies as well as reduce post-processing requirements, mature AM technologies, and promote more widespread use.

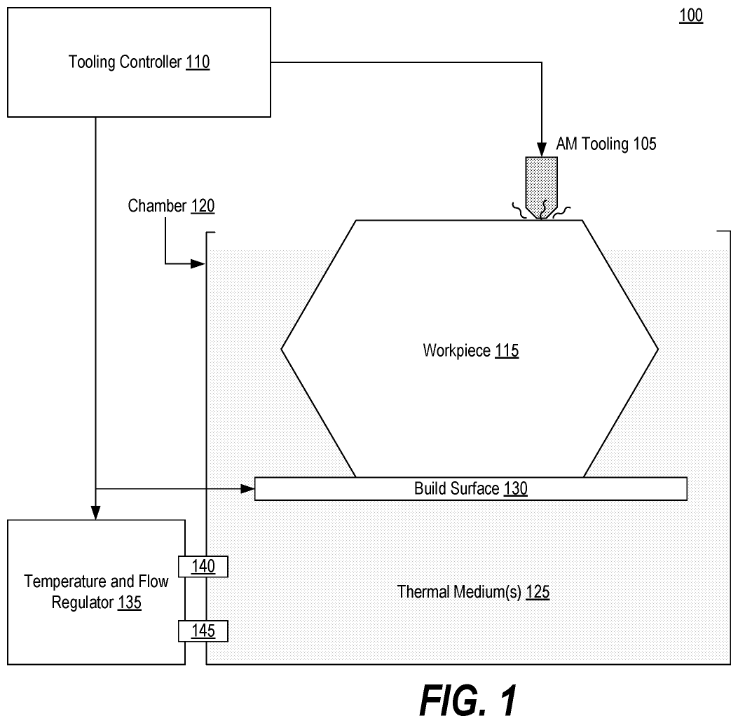

Turning now to the drawings, FIG. 1 shows an example of an additive manufacturing system 100 (or a “system 100” for short) according to various embodiments. The system 100 may include an additive manufacturing (AM) tooling 105 and a tooling controller 110 configured to control and oversee operation of the AM tooling 105. For instance, the tooling controller 110 may direct the AM tooling 105 to heat a material to a predetermined temperature and/or selectively deposit layers of the material, thereby forming a workpiece 115. In other words, the AM tooling 105 may be configured to deposit a heated material to form a 115 workpiece and the tooling controller 110 may be configured direct the AM tooling 105 through a sequence of additive manufacturing process actions. The deposited material (or material to be deposited) may include a polymer, ceramic, metal, or the like.

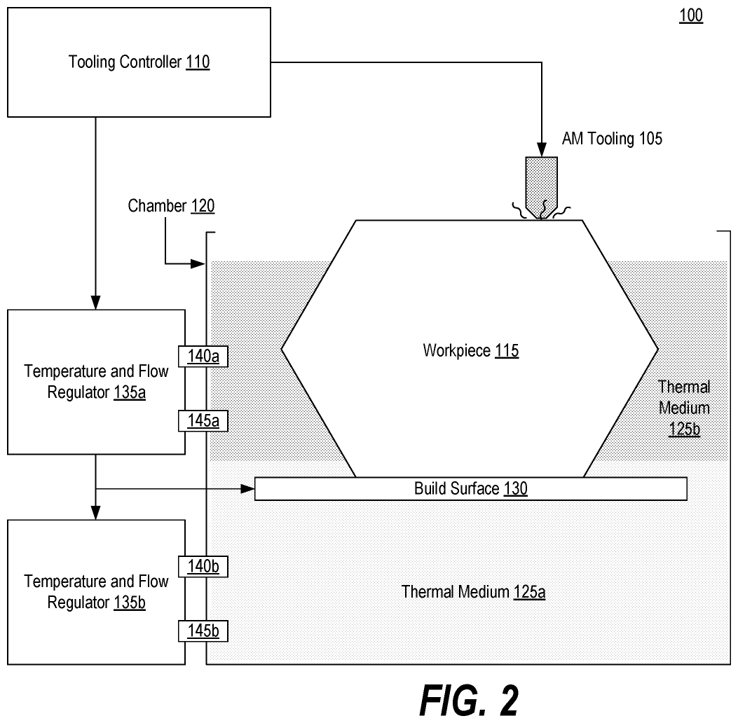

Further, the system 100 may include a chamber 120. The chamber 120 may be capable of containing one or more thermal mediums 125, where the thermal mediums 125 may include gasses, liquids, solids, gels, and any combination thereof. As shown in FIG. 2, the chamber 120 may include two thermal mediums 125, although other number (e.g., three or more thermal mediums 125). In embodiments in which the thermal mediums 125 are liquids, gels, or the like, a first thermal medium 125a may have a density, viscosity, and/or thermal characteristic(s) different than the second thermal medium 125b. Thermal characteristics may include thermal conductivity, ability to act as an insulator, and the like.

As a result, the first thermal medium 125a may maintain a separation between the second thermal medium 125b. In some embodiments, a plate, wall, or other fixture can be used to separate the first thermal medium 125a from the second thermal medium 125b, and so on. As such, while generally referred to as a thermal medium 125 herein, it is understood that the thermal medium 125 may include portions of a thermal medium 125 or a multitude of differing types of thermal mediums 125.

In one example, the at least one thermal medium 125 may include a first thermal medium 125a and a second thermal medium 125b. The tooling controller 110 may selectively control thermal effects of the first thermal medium 125a and the second thermal medium 125b by controlling a relative location and a relative amount of the first thermal medium 125a and the second thermal medium 125b, respectively, where the relative location and relative amount of the first thermal medium 125a and the second thermal medium 125b are controlled by at least one temperature and flow regulator 135 based on at least one of inherit phase, density, solubility, temperature, and viscosity of the first thermal medium 125a and the second thermal medium 125b.

In some aspects, the method may further includes providing a boundary material that separates the first thermal medium and the second thermal medium in the chamber, and selectively controlling the boundary material to be positioned at a predetermined location, where the boundary material restricts mixing of adjacent ones of the first thermal medium and the second thermal medium.

In some aspects the chamber 120 may be expandable or collapsible to adjust for a height or volume of a workpiece 115 and/or involved thermal medium(s) 125 as an additive manufacturing or a coating is implemented. While the term “chamber” is used, it is understood that the chamber may include various types of enclosures, containers, vessels, and the like whether fixed or expandable.

In some embodiments, the system 100 further includes a build surface 130, which also may be referred to as a build plate, a fixture, or a fixture plate. The build surface 130 may be flat or irregular in some implementations. In accordance with various embodiments, the build surface 130 may have a fixed location within the chamber 120. To this end, the tooling controller 110, via a temperature and flow regulator 135, may control a level (and/or an amount) of a thermal medium 125 in the chamber 120 while the build surface 130 and the workpiece 115 have stationary positions.

Alternatively, in some embodiments, the build surface 130 is adjustable in position within the chamber 120. For instance, the build surface 130 may move upwards and downwards via an actuator or other similar mechanism, acting as an elevator to adjust a vertical position of the workpiece 115 relative to a bottom of the chamber 120, as may be appreciated. To this end, the tooling controller 110 may be configured to control a vertical position, horizontal position, or other relative position of the build surface 130 during the sequence of additive manufacturing process actions (e.g., during or after a deposit of a layer of material to form the workpiece 115).

In some embodiments, the system 100 further includes one or more sensors (not shown), such as thermal or temperature sensors. In some embodiments, the one or more sensors may be configured to detect a temperature of the workpiece 115 and a temperature of a portion of the heated material to be deposited. The tooling controller 110 may be further configured to determine a thermal gradient between the workpiece 115 and the portion of the heated material based on the temperature of the workpiece 115 and the temperature of the portion of the heated material to be deposited. The tooling controller 110 may be further configured to control an amount of or a temperature of the at least one thermal medium 125 contained within the chamber over time based at least in part on a predetermined thermal gradient range (e.g., ±1%, ±3%, ±5%, ±10%, and so forth). The thermal gradient may be calculated via:

$$( {T}_{b} - {T}_{a} ) / {Δ}_{x} , \qquad ( eq . 1 )$$

where the temperature at Location A is Tₐ (e.g., the temperature at a top surface of the workpiece 115), the temperature at Location B is T_{b} (e.g., the temperature of the material to be deposited), and the distance between Location A and Location B is Δₓ.

For instance, if a temperature of a workpiece 115 increases such that the workpiece 115 and the temperature of the heated material to be deposited are not within a desired thermal gradient range, the tooling controller 110 may cool the thermal medium 125 via the temperature and flow regulator 135 until the temperature of the workpiece 115 is within a desired thermal gradient range. Likewise, if a temperature of a workpiece 115 decreases such that the workpiece 115 and the temperature of the heated material to be deposited are not within a desired thermal gradient range, the tooling controller 110 may heat the thermal medium 125 via the temperature and flow regulator 135 until the temperature of the workpiece 115 is within a desired thermal gradient range.

As such, the temperature and flow regulator 135 may include one or more heat exchangers, radiators, condensers, compressors, evaporators, and the like to increase or decrease temperature of one or more thermal mediums 125, as may be appreciated. In some embodiments, the tooling controller 110 is configured to control an amount of the at least one thermal medium 125 and the temperature of the at least one thermal medium 125 contained within the chamber at a location proximate to the AM tooling 105 (e.g., at a top surface of the workpiece 115). Additionally, the tooling controller 110, in some embodiments, may control the at least one thermal medium 125 contained within the chamber at particular locations or heights along the workpiece 115. Notably, in some instances, the gradient at the deposition site may not be as important as a bulk temperature of the workpiece 115. As such, the tooling controller 115 may oversee operation of both scenarios. The system 100 may further include an inlet 140 and an outlet 145. The thermal medium 125 may be circulated through the inlet 140 into the temperature and flow regulator 135 and back into the chamber 120 via the outlet 145.

Referring now to FIG. 2, in some embodiments, the thermal medium 125 is a first thermal medium 125a and a second thermal medium 125b. In some embodiments, the system 100 my further include a first temperature and flow regulator 135a for controlling the amount and temperature of the first thermal medium 125a and a second temperature and flow regulator 135b for controlling the amount and temperature of the second thermal medium 125b. To this end, the tooling controller 110 may be configured to control an amount of and the temperature of the first thermal medium 125a contained within the chamber 120 using the first temperature and flow regulator 135a and/or an amount of and the temperature of the second thermal medium 125b contained within the chamber 120 using the second temperature and flow regulator 135b. Accordingly, the system 100 may further include multiple inlets 140a, 140b and/or multiple outlets 145a, 145b, as shown in FIG. 2.

Based on the foregoing, the tooling controller 110 may be configured to heat or cool an entirety of a workpiece 115 or a selected portion thereof at a controlled rate during or after the sequence of additive manufacturing process actions to form the workpiece 115. The tooling controller 110 may be further configured to regulate a first portion of the first thermal medium 125a to a first temperature and to regulate a second portion of the second thermal medium 125b to a second temperature. The first temperature may be higher than the second temperature, as may be appreciated. The first portion of the thermal medium 125 may surrounds a location of the workpiece 115 proximate to the tooling head (e.g., at or near the top surface of the workpiece 115) where the second portion of the thermal medium 125 is below the first portion of the thermal medium 125.

In some embodiments, the system 100 includes one or more sensors (e.g., a third sensor) that are configured to measure an amount of one or more thermal mediums 125 in the chamber 120. For instance, a first sensor (not shown) may measure an amount of a first thermal medium 125a in the chamber 120, a second sensor (not shown) may measure an amount of a second thermal medium 125b in the chamber 120, and so forth. The tooling controller 110 is thereby configured to adjust the temperature of the at least one thermal medium 125 such that a temperature of the workpiece 115 and a temperature of the portion of the heated material to be deposited are within a predetermined thermal gradient range.

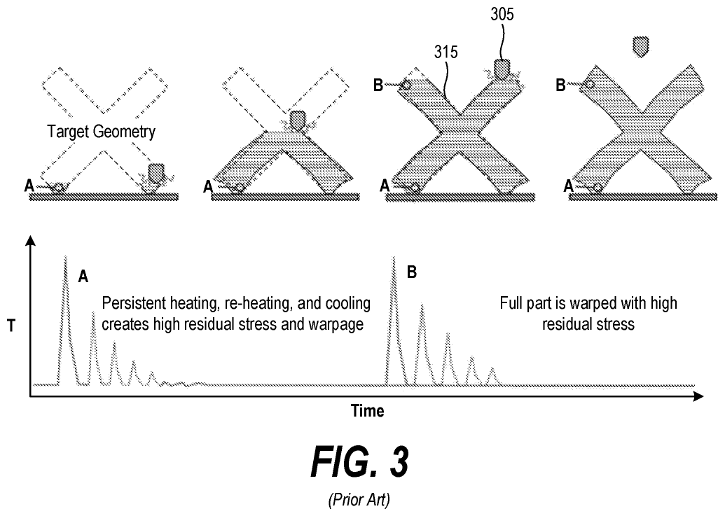

Turning now to FIGS. 3-5, various examples of forming a workpiece 315 in the related art are shown. Specifically, in FIG. 3, a workpiece 315 is shown in which a tooling 305 deposits layers of material until an entirety of the workpiece 315 is formed. Notably, the workpiece 315 is not cooled or heated. Thus, the workpiece 315 is subject to persistent heating, re-heating, and cooling. This creates high-residual stress in the workpiece 315 and may cause warpage due to differences in temperature. The workpiece 315 is ultimately formed with a result inconsistent with that of a target geometry.

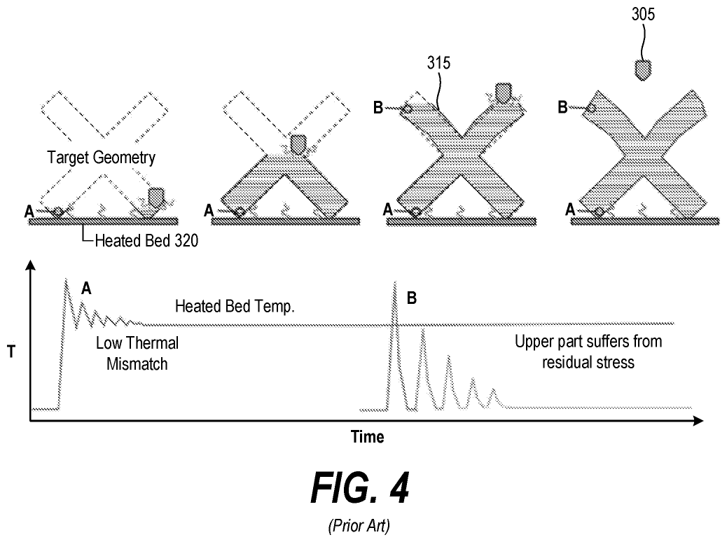

In FIG. 4, a heated bed 320 is employed in the related art to heat a workpiece 315 from a bottom of the workpiece 315. As may be appreciated, the workpiece 315 has a low thermal mismatch as a top of the workpiece 315 may have a temperature substantially different than a bottom of the workpiece 315. The upper part of the workpiece 315 may suffer from residual stress and the like. Again, the workpiece 315 is ultimately formed with a result inconsistent with that of a target geometry.

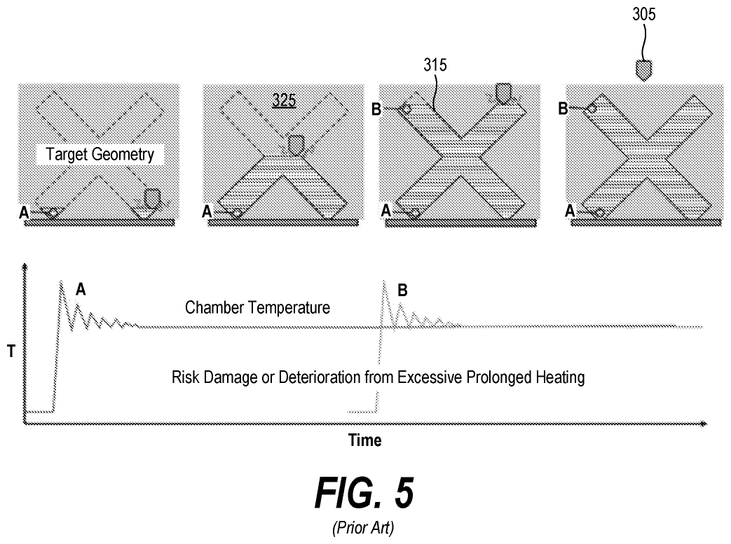

Next, in FIG. 5, a heated chamber 325 is employed in the related art to heat a workpiece 315. As shown in the chart, the chamber temperature varies over time during a deposit of material to form the workpiece 115, resulting in various spikes and drops in temperature. The workpiece 315 is ultimately formed with a result inconsistent with that of a target geometry and there is a risk of damage or deterioration from excessive and prolonged heating.

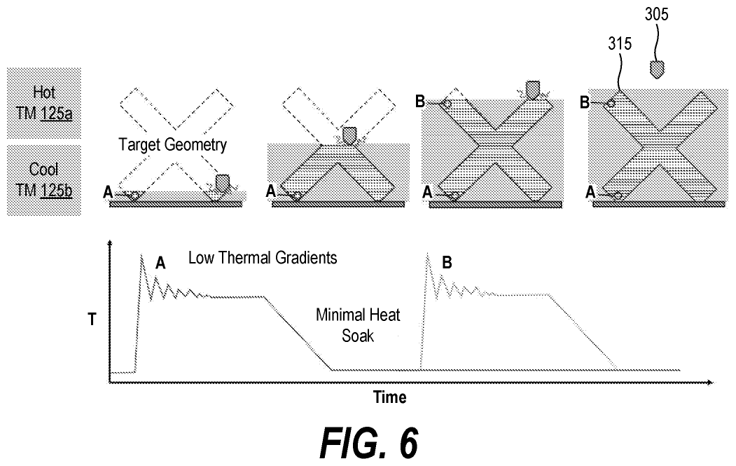

Turning now to FIG. 6, an example of controlling a thermal gradient during a fabrication of a workpiece 115 is shown in accordance with various embodiments described herein. The example of FIG. 6 shows the system 100 of FIG. 1 and/or FIG. 2 forming a workpiece 115 using a hot thermal medium 125a and a cool thermal medium 125b (e.g., hot and cool water). A first portion of the thermal medium 125 may be maintained at a cool temperature, whereas a second portion of the thermal medium 125 may be maintained at a warm or hot temperature during formation of the workpiece 115. The chart portion of FIG. 6 shows temperatures measured at Location A plotted versus time, as well as temperatures measured at Location B plotted versus time. As can be seen from the chart portion of FIG. 6, low thermal gradients are observed over time as well as a minimal heat soak.

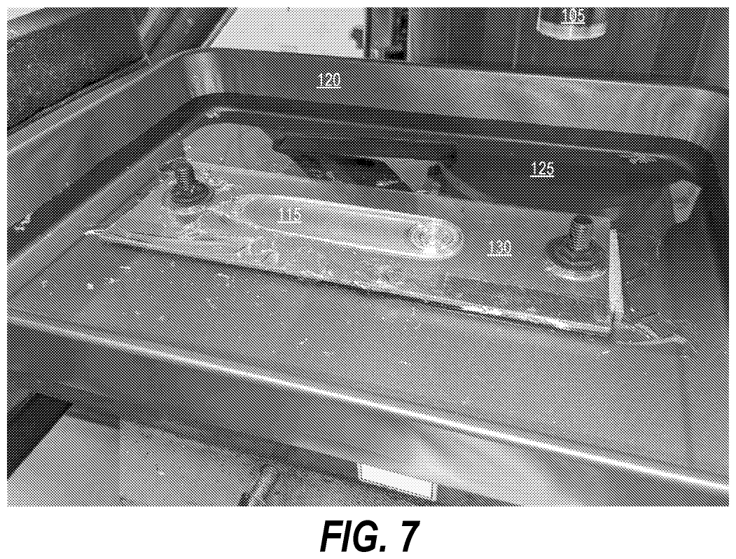

Referring now to FIG. 7, a photograph of a workpiece 115 is shown according to various embodiments. A thermal medium 125, water in this instance, is positioned within a chamber 120. A workpiece 115 is formed on a build surface 130 via an AM tooling 105. A controller (not shown) controls an amount of and a temperature of the thermal medium 125, thereby controlling a temperature of a workpiece 115 (or portion thereof) as well as the temperature gradient.

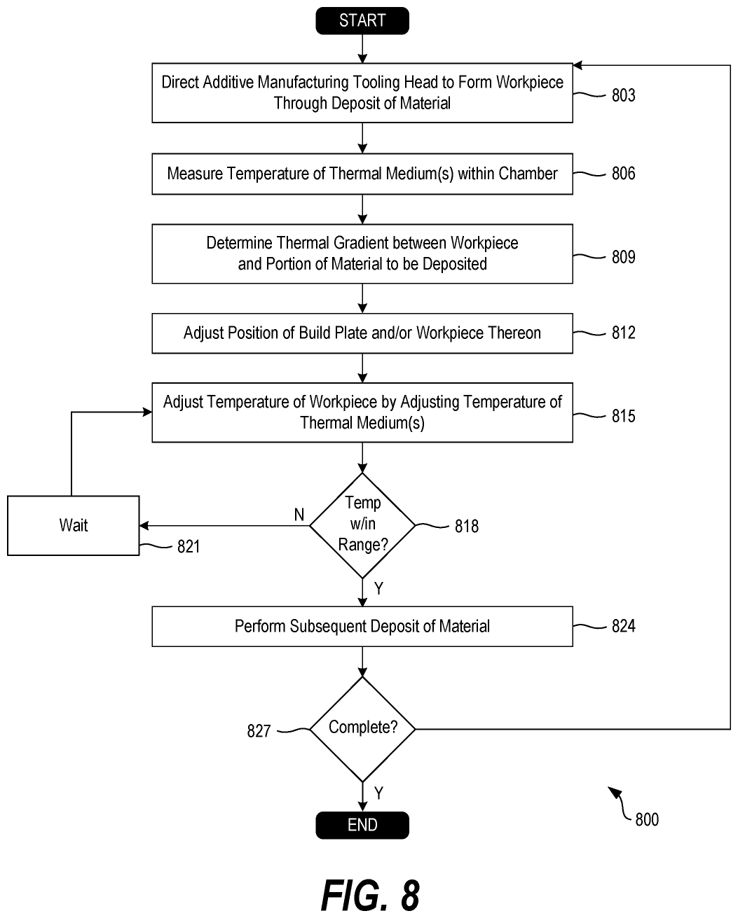

Moving along to FIG. 8, an example of a flowchart 800 is shown according to various embodiments. The flowchart 800 shows an example of controlling a thermal gradient during additive manufacturing. While various actions are described herein as being performed by a tooling controller 110 it is understood that various actions may be performed by one or more controllers separate from or in connection with the tooling controller 110, one or more of which being a microcontroller, processing circuit, computing device, and the like.

Beginning with box 803, a tooling controller 110 may direct an AM tooling 105 (or tooling head) to form a workpiece 115 through a deposit of material. As may be appreciated, this may include heating a material until it melts or otherwise softens, and depositing the material as heated in a prearranged fashion. In other words, a controller may direct an additive manufacturing tooling 105 to form a workpiece 115 through deposit of material according to a sequence of additive manufacturing process actions. The additive manufacturing process actions may include additive manufacturing process actions that are predetermined by a computing device based on a desired shape of a workpiece 115, as can be understood.

Next, at box 806, the tooling controller 110 may measure the temperature of one or more thermal mediums 125 within the chamber 120. This may be performed using one or more temperature sensors, which may include thermal imaging devices, electronic thermal sensors, and the like, as can be appreciated. As such, the controller may measure a temperature of at least one thermal medium 125 within a chamber 120, where the chamber 120 may include a build surface 130 to support the workpiece 115 during the sequence of additive manufacturing process actions.

Next, at box 809, the controller may determine a thermal gradient between a workpiece 115 (or a particular location thereof) and a portion of material to be deposited. The controller may utilize eq. 1 above or other suitable determination.

At box 815, a position of the build surface 130 and/or the workpiece 115 thereon may be adjusted by the controller during the sequence of additive manufacturing process actions. For instance, in some embodiments, the controller may maintain a constant amount of the at least one thermal medium 125 in the chamber 120 and adjust a vertical position of the build surface 130 during the sequence of additive manufacturing process actions.

At box 815, the controller may adjust, the temperature of the at least one thermal medium 125 contained within the chamber 120 over time, for instance, by controlling the temperature and flow regulator 135, based on the sequence of additive manufacturing process actions. This may include elevating the temperature of the at least one thermal medium 125 contained within the chamber 120 at a location proximate to the AM tooling 105. In some embodiments, box 812 may include cooling or heating the workpiece 115 at a controlled rate after the sequence of additive manufacturing process actions to form the workpiece 115. In some embodiments, the controller may regulate a first portion of the at least one thermal medium 125 to a first temperature and relate a second portion of the at least one thermal medium 125 to a second temperature, wherein the first temperature is higher than the second temperature. The controller may also perform the reverse thereof, for instance, when a top surface of the workpiece 115 cools more rapidly. The controller generally may control the thermal gradient, not always reducing the thermal gradient, which may be desirable for quench-type heat treatments. The first portion of the at least one thermal medium 125 may surround a location of the workpiece 115 proximate to the AM tooling 105 where the second portion of the at least one thermal medium 125 is below the first portion of the at least one thermal medium 125.

In some embodiments, the at least one thermal medium 125 contained within the chamber 120 may include a first thermal medium 125a and a second thermal medium 125b. As such, the controller may regulate the first thermal medium 125a to a first temperature and regulating the second thermal medium 125b to a second temperature.

The controller may adjust a temperature of a workpiece 115 (or portion thereof) by adjusting a temperature of one or more of the thermal mediums 125. In some embodiments, the controller may adjust the temperature of the at least one thermal medium 125 such that a temperature of the workpiece 115 and a temperature of the portion of the heated material to be deposited are within the predetermined thermal gradient range.

At box 818, the controller may determine whether the temperature gradient is within a predetermined and permitted temperature gradient range. If not, the process may proceed to box 821 to continue to wait for the temperature of the workpiece 115 to be adjusted via the temperature of the thermal medium 125 by reverting back to box 815. Referring again to box 818, if the controller determined that the temperature gradient is within a predetermined and permitted temperature gradient range, the process may proceed to box 824. At box 824, the controller may direct the AM tooling 105 to perform a subsequent deposit of material. Next, at box 827, a determination is made whether the workpiece 115 has been completely fabricated, coated, etc. If not, the process can revert to box 803 to perform a deposit of another layer or, if formation or coating of the workpiece 115 is complete, the process may proceed to completion.

The system 100 described in accordance with the various embodiments described herein may provide immediate and continuous control of the temperature of a workpiece 115 on a site-by-site basis. In some examples, the system 100 uses a collapsing/expanding chamber 120 filled with one or more thermal mediums 125 as material is deposited during AM, coating, or other like processes. Inherit differences in thermal mediums 125 or applied barrier layers between thermal mediums 125 allow separation that can apply different thermal effects (e.g., temperatures) on a location-by-location basis. In various embodiments, the thermal mediums 125 may be one or more of gasses, liquids, solids, or any combination of the three, with a specific material being selected based on a desired role (e.g., insulation, rapid heating/cooling, or temperature stability). This may allow for control of the instantaneous temperature and heating/cooling rates, which can be kept above or below the nominal conditions associated with the manufacturing system. Combining these features allows for discrete control of the complete thermal profile for the manufactured workpiece 115, including temperature rate changes, isothermal holds, and controlled thermal gradients. The thermal control enabled by this system 100 may improve the capabilities of several technologies, as well as helping to reduce post-processing requirements, maturing the technologies, and allowing for more widespread use.

In further aspects, a method for coating a workpiece 115 is described that includes directing, with a controller (e.g., tooling controller 110), a tooling head (e.g., AM tooling 105) to coat a workpiece 115 (as opposed to formation) through deposit of material according to a sequence of coating process actions: measuring, with the controller, a temperature of at least one thermal medium 125 within a chamber 120, the chamber 120 comprising a build surface 130 to support the workpiece 115 during the sequence of coating process actions: and adjusting, with the controller, the temperature of the at least one thermal medium 125 contained within the chamber over time, by control of a temperature regulator (e.g., temperature and flow regulator 135), based on the sequence of coating process actions. While example additive manufacturing processes are described, each embodiment may be applied to coating processes as well.

The features, structures, or characteristics described above may be combined in one or more embodiments in any suitable manner, and the features discussed in the various embodiments are interchangeable, if possible. In the following description, numerous specific details are provided in order to fully understand the embodiments of the present disclosure. However, a person skilled in the art will appreciate that the technical solution of the present disclosure may be practiced without one or more of the specific details, or other methods, components, materials, and the like may be employed. In other instances, well-known structures, materials, or operations are not shown or described in detail to avoid obscuring aspects of the present disclosure.

Although the relative terms such as “on,” “below,” “upper,” and “lower” are used in the specification to describe the relative relationship of one component to another component, these terms are used in this specification for convenience only, for example, as a direction in an example shown in the drawings. It should be understood that if the device is turned upside down, the “upper” component described above will become a “lower” component. When a structure is “on” another structure, it is possible that the structure is integrally formed on another structure, or that the structure is “directly” disposed on another structure, or that the structure is “indirectly” disposed on the other structure through other structures.

In this specification, the terms such as “a,” “an,” “the,” and “said” are used to indicate the presence of one or more elements and components. The terms “comprise,” “include,” “have,” “contain,” and their variants are used to be open ended, and are meant to include additional elements, components, etc., in addition to the listed elements, components, etc. unless otherwise specified in the appended claims.

The terms “first,” “second,” etc. are used only as labels, rather than a limitation for a number of the objects. It is understood that if multiple components are shown, the components may be referred to as a “first” component, a “second” component, and so forth, to the extent applicable. If “one or more” components are described, it is understood that the term “one or more” may refer to “at least one” of the components or a “plurality of” the components unless otherwise specified.

The above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

1. A system for additive manufacturing, comprising:
an additive manufacturing tooling head configured to deposit a heated material to form a workpiece;
a tooling controller configured direct the tooling head through a sequence of additive manufacturing process actions;
a chamber comprising a build surface to support the workpiece during the sequence of additive manufacturing process actions;
at least one thermal medium contained within the chamber; and
at least one sensor configured to detect a temperature of the workpiece and a temperature of a portion of the heated material to be deposited;
wherein the tooling controller is further configured to:
determine a thermal gradient between the workpiece and the portion of the heated material based on the temperature of the workpiece and the temperature of the portion of the heated material to be deposited; and
control the at least one thermal medium contained within the chamber over time based at least in part on a predetermined thermal gradient range.

2. The system for additive manufacturing according to claim 1, further comprising a temperature and flow regulator for the at least one thermal medium, wherein the tooling controller is configured to control an amount of the at least one thermal medium and adjust the temperature of the at least one thermal medium contained within the chamber at a location proximate to the tooling head.

3. The system for additive manufacturing according to claim 1, wherein:
the at least one thermal medium is a first thermal medium and a second thermal medium;
the system further comprises a first temperature and flow regulator for the first thermal medium and a second temperature and flow regulator for the second thermal medium;
the tooling controller is configured to control an amount of and the temperature of the first thermal medium contained within the chamber using the first temperature regulator; and
the tooling controller is configured to control an amount of and the temperature of the second thermal medium contained within the chamber using the second temperature regulator.

4. The system for additive manufacturing according to claim 3, wherein the first thermal medium has a density, viscosity, and thermal characteristic different than the second thermal medium.

5. The system for additive manufacturing according to claim 1, wherein the tooling controller is further configured to cool or heat the entire workpiece at a controlled rate after the sequence of additive manufacturing process actions to form the workpiece.

6. The system for additive manufacturing according to claim 1, wherein:
the tooling controller is further configured to regulate a first portion of the at least one thermal medium to a first temperature and to regulate a second portion of the at least one thermal medium to a second temperature;
the first temperature is higher than the second temperature; and
the first portion of the at least one thermal medium surrounds a location of the workpiece proximate to the tooling head and the second portion of the at least one thermal medium is below the first portion of the at least one thermal medium.

7. The system for additive manufacturing according to claim 1, wherein the build surface is adjustable in position within the chamber, and the tooling controller is configured to control a position of the build surface during the sequence of additive manufacturing process actions.

8. The system for additive manufacturing according to claim 7, wherein the build surface is vertically adjustable in position within the chamber, and the tooling controller is configured to control a vertical position of the build surface during the sequence of additive manufacturing process actions.

9. The system for additive manufacturing according to claim 1, wherein:
the at least one sensor is a first sensor configured to measure a temperature of the workpiece and a second sensor configured to measure a temperature of a portion of the heated material to be deposited; and
the system further comprises a third sensor configured to measure an amount of the at least one thermal medium in the chamber.

10. The system for additive manufacturing according to claim 1, wherein the tooling controller is further configured to adjust the temperature of the at least one thermal medium such that a temperature of the workpiece and a temperature of the portion of the heated material to be deposited are within the predetermined thermal gradient range.

11. A method for use in additive manufacturing, comprising:
directing, with a controller, an additive manufacturing tooling head to form a workpiece through deposit of material according to a sequence of additive manufacturing process actions;
measuring, with the controller, a temperature of at least one thermal medium within a chamber, the chamber comprising a build surface to support the workpiece during the sequence of additive manufacturing process actions; and
adjusting, with the controller, the temperature of the at least one thermal medium contained within the chamber over time, by control of a temperature regulator, based on the sequence of additive manufacturing process actions.

12. (canceled)

13. The method according to claim 11, further comprising cooling or heating the workpiece at a controlled rate after the sequence of additive manufacturing process actions to form the workpiece.

14. The method according to claim 11, further comprising regulating a first portion of the at least one thermal medium to a first temperature and regulating a second portion of the at least one thermal medium to a second temperature, wherein the first temperature is higher than the second temperature.

15. The method according to claim 14, wherein the first portion of the at least one thermal medium surrounds a location of the workpiece proximate to the tooling head and the second portion of the at least one thermal medium is below the first portion of the at least one thermal medium.

16. The method according to claim 11, wherein:
the at least one thermal medium contained within the chamber comprises a first thermal medium and a second thermal medium; and
the method further comprises regulating the first thermal medium to a first temperature and regulating the second thermal medium to a second temperature.

17. (canceled)

18. The method according to claim 11, further comprising maintaining a constant amount of the at least one thermal medium in the chamber and adjusting a vertical position of the build surface during the sequence of additive manufacturing process actions.

19. The method according to claim 11, further comprising:
measuring, by a first sensor, a temperature of the workpiece;
measuring, by a second sensor, a temperature of a portion of the heated material to be deposited; and
measuring, by a third sensor, an amount of the at least one thermal medium in the chamber.

20. The method according to claim 11, further comprising adjusting, by the controller, the temperature of the at least one thermal medium such that a temperature of the workpiece and a temperature of the portion of the heated material to be deposited are within the predetermined thermal gradient range.

21. The method according to claim 11, wherein:
the at least one thermal medium comprises a first thermal medium and a second thermal medium;
selectively controlling, by the controller, thermal effects of the first thermal medium and the second thermal medium by controlling a relative location and a relative amount of the first thermal medium and the second thermal medium, respectively, wherein the relative location and relative amount of the first thermal medium and the second thermal medium are controlled by at least one temperature and flow regulator based on at least one of inherit phase, density, solubility, temperature, and viscosity of the first thermal medium and the second thermal medium.

22. The method according to claim 21, further comprising:
providing a boundary material that separates the first thermal medium and the second thermal medium in the chamber, and
selectively controlling the boundary material to be positioned at a predetermined location, wherein the boundary material restricts mixing of adjacent ones of the first thermal medium and the second thermal medium.

23. (canceled)
